(19) United States
(12) Patent Application Publication
(10) Pub. No.: US 2014/0160979 A1
(43) Pub. Date: Jun. 12, 2014

(54) Determination and Visualization of Hierarchical Network Topology

(71) Applicant: FUTUREWEI TECHNOLOGIES, INC., Plano, TX (US)

(72) Inventors: Kenneth Durazzo, San Ramon, CA (US); Yunxia Chen, Fremont, CA (US)

(73) Assignee: Futurewei Technologies, Inc., Plano, TX (US)

(21) Appl. No.: 13/712,197

(22) Filed: Dec. 12, 2012

(51) Int. Cl. H04L 12/24

(52) U.S. Cl. CPC H04L 41/12
USPC 370/254

(57) ABSTRACT

A method includes interrogating devices in a network to obtain device information. Based on the device information, the method includes automatically determining which devices are at a top layer of a multi-layer hierarchical topology, wherein the devices at the top layer are core devices. The method further includes receiving input from a user to manually modify the determination as to which devices are the core devices. The method further includes determining which of the other devices in the network are at another layer in the hierarchical topology based on the core devices.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Network designers design networks based upon hierarchical roles and characteristics. However, tools that provide a visualization of the network may only show physical connections between devices in the network, and may not determine and show the hierarchical topology of the network.

### SUMMARY

In one embodiment, the disclosure provides a method that includes interrogating devices in a network to obtain device information. Based on the device information, the method includes automatically determining which devices are at a top layer of a multi-layer hierarchical topology, wherein the devices at the top layer are core devices. The method further includes receiving input from a user to manually modify the determination as to which devices are the core devices. The method further includes determining which of the other devices in the network are at another layer in the hierarchical topology based on the core devices.

In another embodiment, the disclosure is directed to a non-transitory, computer-readable storage device that contains software. When executed by a processor, the software causes the processor to interrogate devices in a network to obtain device information. Based on the device information, the software causes the processor to automatically determine which devices are at a top layer of a multi-layer hierarchical topology, wherein the devices at the top layer are core devices, as well as receive input from a user to manually modify the determination as to which devices are the core devices. The software causes the processor to determine which of the other devices in the network are at another layer in the hierarchical topology based on the core devices.

Another embodiment is directed to a computing device that includes a processor, a network interface coupled to the processor, and a storage device coupled to the processor. The storage device includes software that causes the processor to interrogate devices in a network to obtain device information. Based on the device information, the software causes the processor to automatically determine which devices are at a top layer of a multi-layer hierarchical topology, and receive input from a user to manually modify the determination as to which devices are at the top layer. Based on those devices being determined to be core network devices, the software causes the processor to determine which of the other devices in the network are at another layer in the hierarchical topology.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 shows an example of a network depicting various physical connections between network devices;

FIG. 2 shows a block diagram of a management workstation in accordance with a preferred implementation;

FIG. 3 illustrates the hierarchical topology of the network of FIG. 1;

FIG. 4 shows a method of determining the network's hierarchical topology in accordance with a preferred embodiment;

FIG. 5 illustrates a graphical user interface in which topology information is provided to a user and the user is able to modify various automatically made topology determinations;

FIG. 6 shows a method of determining which devices are in layers other than a top layer in accordance with a preferred embodiment; and

FIG. 7 provides another illustration of the method of determining the network's hierarchical topology and its visual depiction to a user.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

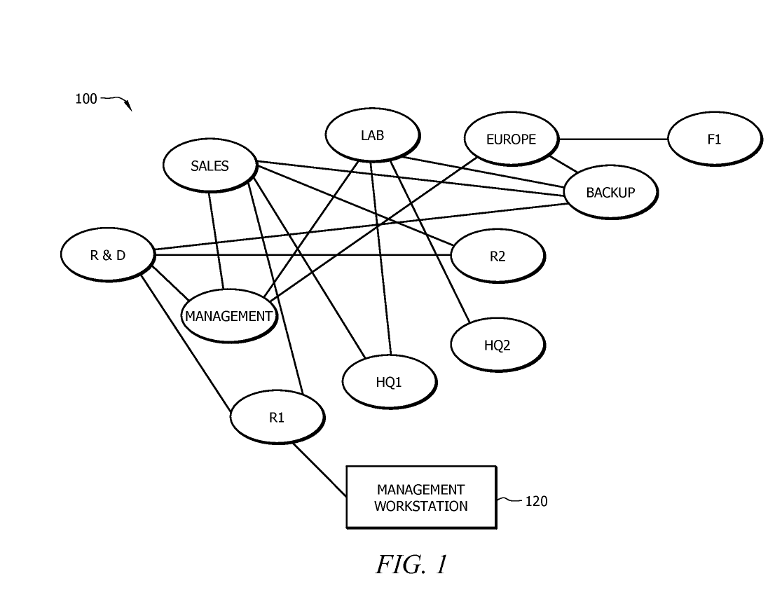

FIG. 1 shows an example of a network 100. The illustrative network 100 includes various network devices such as switches, routers, servers, storage devices, and the like. The devices shown in FIG. 1 may be referred to by an alphanumeric name such as R&D, SALES, R1, MANAGEMENT (MGT), LAB, R2, HQ2, EUROPE, BACKUP, F1, and HQ1. The device names shown in FIG. 1 are provided only for illustrative purposes and could be any designations appropriate for a given network. Each such device shown in FIG. 1 may be implemented as any desired type of network device such as a switch, router, server, storage device, and the like. When each such device is initially installed and provisioned into the network, network maintenance personnel may provide a desired name for the device at that time.

The lines interconnecting the various devices in network 100 represent physical direct connections. For example, the R&D device is shown with connections to each of the BACKUP, R2, MGT, and R1 devices indicating the R&D device has direct physical connections just to those four devices. The R&D device does not directly connect to the EUROPE device, but does directly connect to the BACKUP device, which itself directly connects to the EUROPE device. Two devices that are directly connected together are deemed “one hop” away from each other, while two devices that directly connect to the same device but not to each other are deemed “two hops” away from each other. Thus, the R&D device is one hop away from the BACKUP device and is two hops away from the EUROPE device.

FIG. 1 also shows a management workstation 120 coupled to one of the devices in the network. As described in detail below, the management workstation 120 determines the hierarchical topology of the network 100 and provides the topology to a user of the workstation. The workstation may be coupled to any of the devices in the network.

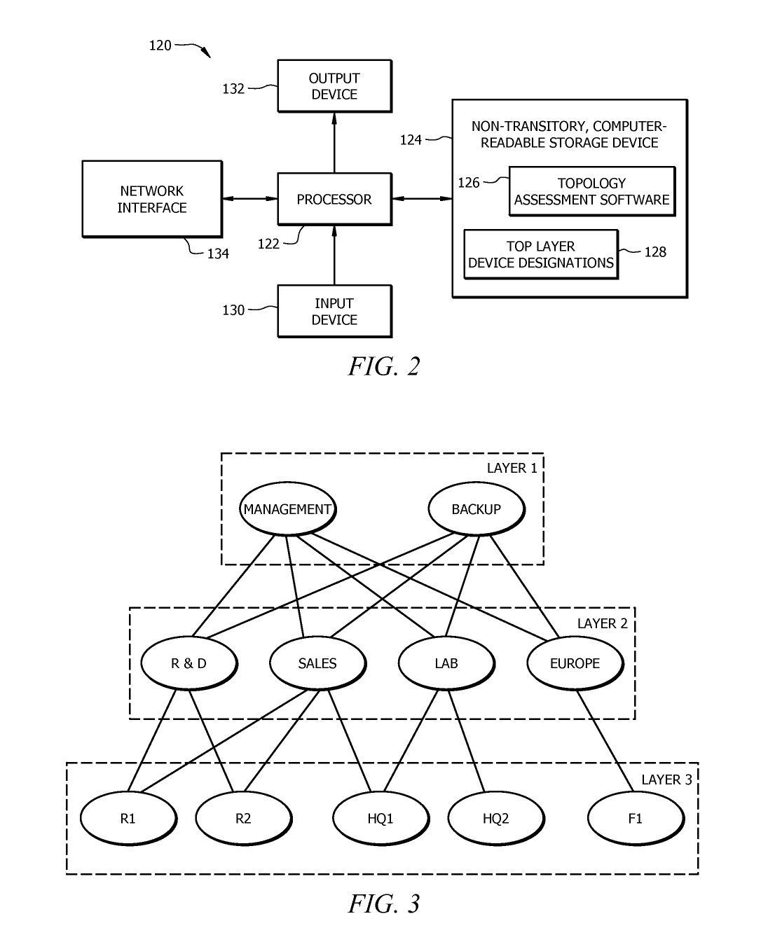

FIG. 2 illustrates a block diagram of the management workstation 120. As shown, the management workstation 120 includes one or more processors 122. All references herein to “a processor” include embodiments having only a single processor as well as embodiments having multiple processors, and include both general-process processors as well as application-specific integrated circuits (ASICs). The processor 122 preferably is coupled to a non-transitory, computer-readable storage device 124, an input device 130, an output device 132, and a network interface 134. The non-transitory, computer-readable storage device 124 preferably includes volatile storage such as random access memory (RAM), non-volatile storage such as a hard disk drive, Flash storage, a compact disc read-only memory (CD ROM), etc., or combinations of both volatile and non-volatile storage. The input device 130 may comprise a keyboard, mouse, trackball, track pad, or other type of input device. The output device 132 may include a display, printer, or other type of device to provide information to a user of the workstation. In some cases, the input device 130 and the output device 132 may be combined into a single device, e.g. a touchscreen interface. Then network interface 134 preferably comprises a wireless transceiver, a network interface controller (NIC), and/or other type of network interface module to provide the workstation 120 with connectivity to the network 100.

As shown in FIG. 1, the non-transitory, computer-readable storage device 124 includes topology assessment software 126, which comprises code that is executable by processor 122. The processor 122, upon executing software 126, imparts the workstation 120 with some or all of the functionality described herein. The storage device 124 also includes the top layer designations 128, described in detail below. The designations may be stored in any suitable type of data structure.

FIG. 1 is useful to illustrate the physical connections between the various devices of the network 100. However, the layout of FIG. 1 does not illustrate the hierarchical topology of the network. FIG. 3 illustrates another layout of network 100 showing the network's hierarchical topology, which is how the designer may have designed the network. A hierarchical topology may be defined as the layout pattern of interconnections of the various elements (links, nodes, etc.) of a computer network. The topological layout of FIG. 3 illustrates multiple “layers.” The network 100 may include any number of layers including 1 layer, 2 layers, 3 layers, etc. The example of FIG. 3 illustrates that the network 100 has three layers designated as LAYER1, LAYER2, and LAYER3. LAYER1 includes the MGT and BACKUP devices. LAYER2 includes the R&D, SALES, LAB, and EUROPE devices. LAYER3 includes the R1, R2, HQ1, HQ2, and F1 devices.

LAYER1 is designated as the “top layer” of the network. In some implementations, the top layer may also be referred to as the “core” layer, while layers LAYER2 and LAYER3 are referred to as the “distribution” and “access” layers, respectively. In such implementations, devices in the core layer are responsible for transporting large amounts of data reliably and quickly. Core layer devices generally switch traffic faster than distribution and access layer devices, and may not be directly connected to any end-user workstations or other devices.

The distribution layer includes devices that are responsible for providing communication between the core and access layers. Functions that may be performed by distribution layer devices include routing, filtering, network access and determining how devices can access the core layer as necessary. Network polices may be implemented in the distribution layer. An illustrative list of distribution layer functions includes: access lists, packet filtering, queuing; security and network policies such as address translation and firewalling; re-distribution between routing protocols including static routing; departmental and workgroup access; definition of broadcast and multicast domains; and media transitions. Distribution layer devices generally switch traffic faster than access layer devices, but slower than core layer devices. The distribution layer devices may include devices directly connected to the core layer devices and/or the access layer devices. In an embodiment, the distribution layer devices may be exactly one hop away from the core layer devices.

The access layer controls end user access to internetwork resources. The access layer generally is the connectivity point for end user devices, and access layer devices generally are not directly connected to core layer devices. In an embodiment, the access layer devices may be exactly two hops away from the core layer devices. Access layer devices generally switch traffic slower than distribution and core layer devices.

As noted above, the various layers LAYER1-LAYER3 may be implemented as core, distribution, and access layers in some embodiments. In other embodiments, the various layers implement functionality other than that of the core, distribution, and access layers. The functionality of the various layers of the network may include whatever is intended for each such layer by the network designer.

While FIG. 1 illustrates physical connectivity, FIG. 3 illustrates the hierarchical topology of the network. The processor 122, upon executing topology assessment software 126, determines the hierarchical topology of the network. That is, the processor 122 determines which devices are included in each layer of the network's topology, and provides a graphical depiction of the topology to the user of the management workstation 120. The graphical depiction may be in the form shown in FIG. 3 or in any other visual form.

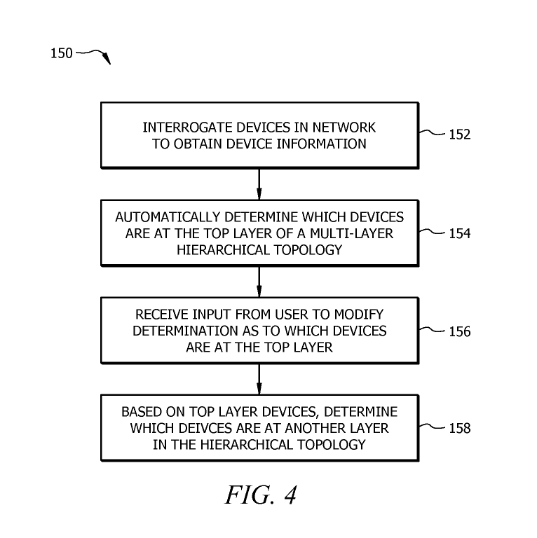

FIG. 4 shows an illustrative method 150 by which the management workstation 120 and its processor 122 determine the hierarchical topology of network 100. The operations depicted in FIG. 4 can be performed in the order shown or in a different order. Further, two or more of the operations of FIG. 4 may be performed in parallel rather than serially. The method of FIG. 4 may be performed by the processor 122 any time after the network 100 has initialized itself. During such an initialization process, each device exchanges messages with adjacent devices (e.g., devices directly connected to the device). During this message exchange, each device in the network is able to determine the Internet Protocol (IP) address of its immediate neighbors. The method 150 may be performed at any time after each device determines the IP addresses of its immediate neighbors.

At block 152, the method 150 includes interrogating the devices of the network 100 to obtain “device information” from each such device. The process of interrogating the network's devices may include the management workstation 120 broadcasting an interrogation message to the IP address of each device in the network. In response to the interrogation message, each device reports its device information to the management workstation 120. The device information may include the device's designation as well as the IP addresses of all devices directly connected to the device (e.g., the device's local topology). The device designation may include any type of information that identifies the device. Examples of device designation include a model designation, a product description, etc. An interrogated device may also report its device name (e.g., R&D, LAB, etc.).

At block 154, the method 150 includes automatically determining which devices in the network are at the top layer of the hierarchical topology. The top layer designations 128 shown in FIG. 1 preferably include designations of devices that are deemed devices typical of the top layer. Such designations may be pre-stored by a user and may be updated as explained below during operation of the topology assessment software 126. By comparing the top layer device designations 128 to the device designations reported to the management workstation 120 in response to the broadcasted interrogation messages, the method 150 determines which devices are part of the top layer of the hierarchical topology. For example, the method 150 determines that a device that reports a device designation that matches a designation in the top layer designations 128 is a device in the top layer LAYER1 of the network's hierarchical topology.

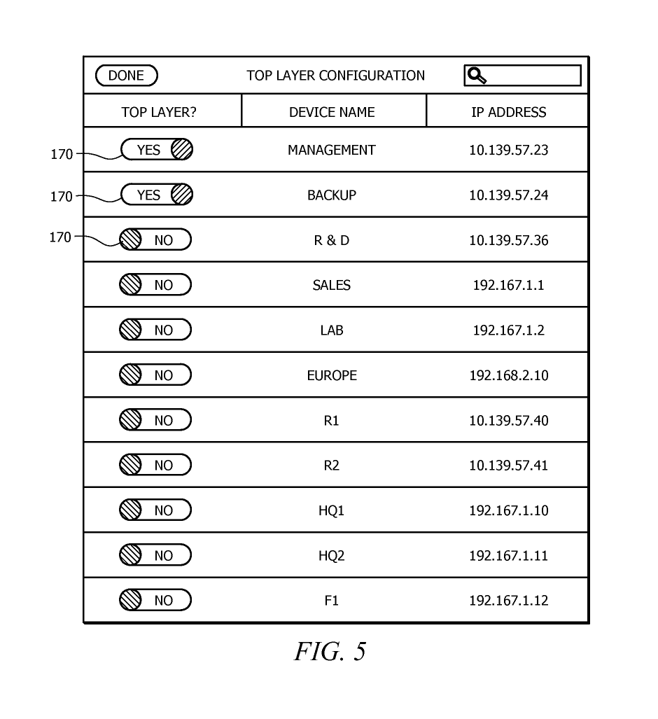

A user may be provided with the ability to alter the automatic top layer determinations made by the method 150. At block 156, the method 150 receives input from the user of the management workstation 120 to modify the determinations made in operation 154 as to which devices are at the top layer of the topology. FIG. 5 shows an example of a graphical user interface (GUI) presented to the user on the management workstation 120. The example shown in FIG. 5 shows some or all of the various devices detected in the network by the workstation during the interrogation process of block 152. The center column in the GUI of FIG. 5 provides the device name and the right-hand column shows the IP address of each such device. The left-hand column provides feedback to the user as which devices were deemed automatically by the method 150 in block 154 to be top layer devices. In the example of FIG. 5 and consistent with the topology example of FIG. 3, the processor 122 determined the MGT and BACKUP devices to be top layer devices as visually indicated to the user via the “YES” slider button 170 in the left-hand column. The slider buttons 170 beside all other devices are labeled with “NO” to indicate such devices were not determined to be top layer devices by processor 122. However, each slider button 170 can be manually adjusted by a user to change a “YES” to a “NO,” and vice versa. Thus, the user can re-designate either or both of the MGT and BACKUP devices as non-top layer devices and re-designate any of the other (R&D, SALES, LAB, etc.) devices as top layer devices.

Referring again to FIG. 4, based on the automatic determination at block 154 of the top layer devices (as potentially modified by the user at 156), at block 158 the method 150 determines which devices are at another layer besides the top layer in the hierarchical topology. The method 150 may make this determination based on, for example, the IP addresses reported by each interrogated device of the devices to which the interrogated device is directly connected. For example, if an interrogated device reports that it is connected to a device whose IP addresses matches that of a device determined to be a top layer device, then the method 150 determines that the interrogated device is one hop away from the top layer LAYER1 and thus is a LAYER2 device in the illustrative topology of FIG. 3. If an interrogated device reports that it is connected to a device whose IP address does not match that of a top layer device, the method 150 determines the device to be a LAYER3 device in the example of FIG. 3. That is, a device that is not in layers LAYER1 (top layer) or LAYER2 may automatically be deemed to be in LAYER3.

Alternatively, if an interrogated device reports that it is connected to a device whose IP address does not match that of a top layer device but does match a device determined to be connected to a top layer device, the method 150 determines the interrogated device to be two hops away from the top layer. That is, for a device to be designated as being in LAYER3, the device has to have been determined not to be in layers LAYER1 or LAYER2 and must be connected to a device in LAYER2. In this example, all other devices not determined to be in layers LAYER1, LAYER2, or LAYER3, may be lumped together as “other.”

Further still, if the topology has more than three layers, the processor 122 determines which devices are in each layer based on the local topology connectivity reported by each device in the network. Thus, a device that is one hop away from the top layer LAYER1 is deemed to be in LAYER2. A device that is two hops away from the top layer is deemed to be in LAYER3. A device that is three hops away from the top layer is deemed to be in a fourth layer (LAYER4, not shown in FIG. 3), and so on.

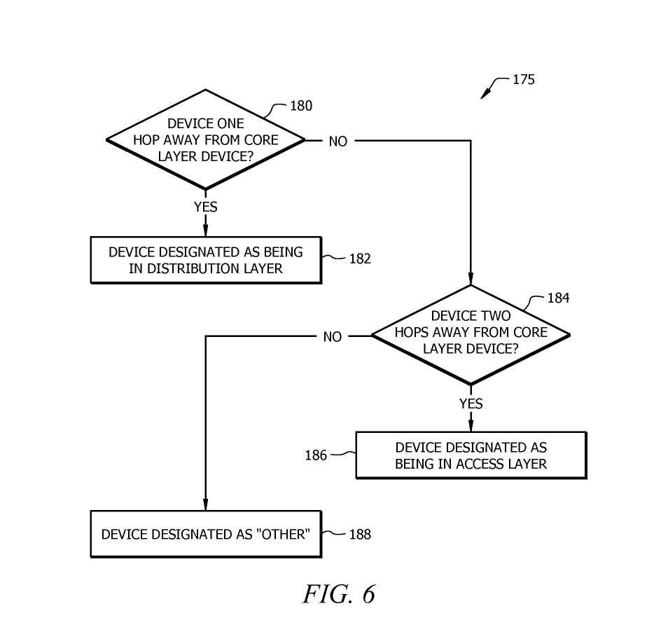

For a network that implements the core-distribution-access topology model, FIG. 6 illustrates a method 175 by which the non-core devices are designated as being in distribution or access layers. Method 175 may be implemented by processor 122. The devices determined to be core devices have already been made before the method 175 begins. At block 180, the processor 122 determines whether the local connectivity information (e.g., IP addresses) reported by a given interrogated device indicates that the device is one hop away from a core layer (e.g., directly connected to a core device). If so, the device is designated as being in the distribution layer at block 182. If not, then method 175 determines whether the device is two hops away from the core layer (e.g., connected to a distribution layer device) at block 184. If the device is determined to be two hops away from the core layer, the device is designated as being in the access layer at block 186. If, however, the device is not determined to be in the access layer, the device is designated at block 188 as “other.”

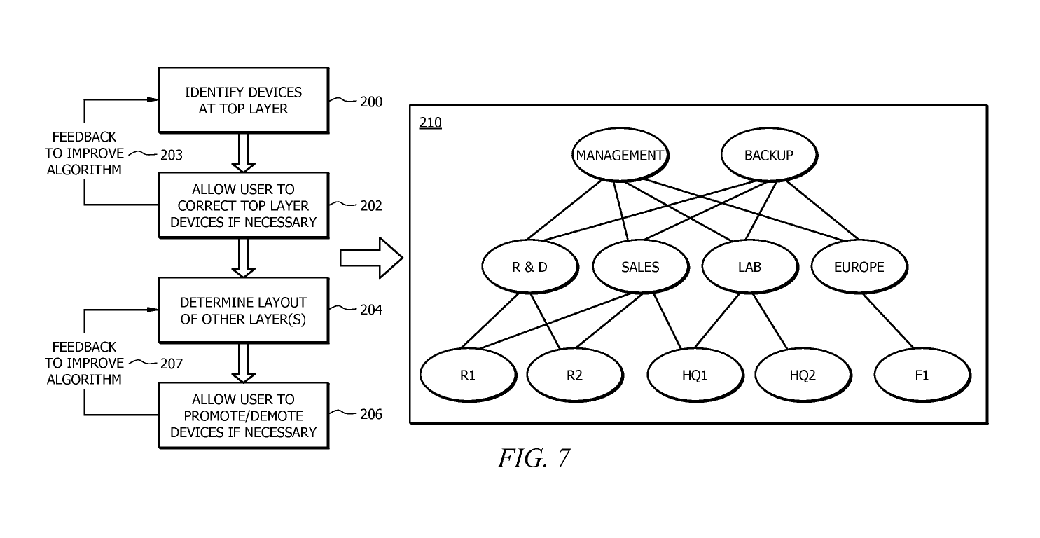

FIG. 7 provides another illustration of the hierarchical topology determination and visualization process 190, which may be implemented by management workstation 120. At block 200, the process 190 identifies which devices are at the top layer. At block 202, the process 190 allows a user to correct the top layer devices, if necessary. At block 204, the process 190 determines the layout of the other layer(s), and again permits the user to make corrections to the layout determined by the management workstation's software at block 206. Once the network's hierarchical topology is determined, a visual representation may be presented to the user, for example via output device 132 (e.g., displayed, printed, etc.) as shown in 210. The various layers are visually demarcated for the user.

In some embodiments, when a user adjusts which device(s) is (are) determined to be top layer devices, such adjustments are provided to the management workstation's software as feedback for future top layer device determinations. Feedback arrows 203 and 207 in FIG. 7 indicate such feedback. For example, the processor 122 may update the top layer device designations 128 in the non-transitory, computer-readable storage device 124. As such, when the processor 122 again uses the top layer device designations 128 to make the automatic determination as to which devices are top layer devices, the determination will be made based on the previous feedback provided by the user as to which devices the user considers top layer devices.

In some embodiments, the user may re-designate a device's status as to whether the device is a top layer device, but the user can direct the management workstation 120 (via a selectable software button) not to use the re-designation to update the top layer device designations 128. As such, the user feedback will not be used during future top layer device assessments made by the management workstation 120. However, the particular device whose topology status is modified is shown in the GUI's topology layout as being in the layer specified by the user.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k* (Rᵤ−R₁), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method, comprising:
interrogating devices in a network to obtain device information;
automatically determining which devices are at a top layer of a multi-layer hierarchical topology based on the device information, wherein the devices at the top layer are core devices;
receiving input from a user to manually modify the determination as to which devices are the core devices; and
determining which of the other devices in the network are at another layer in the hierarchical topology based on the core devices.

2. The method of claim 1, wherein determining which devices are at the top layer comprises comparing the device information obtained from the devices during interrogation to a stored set of device designators previously deemed to be indicative of core devices.

3. The method of claim 1 further comprising re-designating one of the devices not automatically determined to be at the top layer to be at the top layer based on the input received from the user.

4. The method of claim 1 further comprising re-designating one of the devices previously determined to be at the top layer to be at a layer other than the top layer based on the input received from the user.

5. The method of claim 1 further comprising adjusting an automatic determination as to which devices are at the top layer based on the received input from the user.

6. The method of claim 5, wherein adjusting the automatic determination as to which devices are at the top layer comprises updating a data structure containing top layer device designations based on the input received from the user.

7. The method of claim 1, wherein determining which of the other devices in the network at another layer in the hierarchical topology comprises identifying devices that are one hop away from the core devices and separately identifying devices that are two hops away from the core devices.

8. The method of claim 7, wherein identifying devices that are one hop away from the core devices comprises identifying devices that directly connect to core devices, and wherein identifying devices that are two hops away from the core devices comprises identifying devices that do not directly connect to the top layer, but directly connect to devices that directly connect to the core devices.

9. The method of claim 7 further comprising graphically representing the hierarchical topology, wherein the graphical representation demarcates the top layer, a layer containing devices determined to be one hop away from the core devices, and a layer containing devices determined to be two hops away from the core devices.

10. The method of claim 1 further comprising graphically representing the hierarchical topology, wherein the graphical representation demarcates the top layer from the other layers.

11. A non-transitory, computer-readable storage device containing software that, when executed by a processor, causes the processor to:
interrogate devices in a network to obtain device information;
automatically determine which devices are at a top layer of a multi-layer hierarchical topology based on the device information, wherein the devices at the top layer are core devices;
receive input from a user to manually modify the determination as to which devices are the core devices; and
determine which of the other devices in the network are at another layer in the hierarchical topology based on the core devices.

12. The non-transitory, computer-readable storage device of claim 11, wherein the software causes the processor to determine which devices are core devices by comparing the device information obtained from the devices during interrogation to a stored set of device designators previously deemed to be indicative of the core devices.

13. The non-transitory, computer-readable storage device of claim 11, wherein the software causes the processor to adjust an automatic determination as to which devices are the core devices based on the received input from the user.

14. The non-transitory, computer-readable storage device of claim 13, wherein the software causes the processor to adjust the automatic determination as to which devices are the core devices by updating a data structure containing top layer device designations based on the input received from the user.

15. The non-transitory, computer-readable storage device of claim 11, wherein the software causing the processor to determine which of the other devices in the network at another layer in the hierarchical topology comprises the software causing the processor to identify devices that are one hop away from the core devices and to identify devices that are two hops away from the core devices.

16. The non-transitory, computer-readable storage device of claim 15, wherein the software causes the processor to identify devices that are one hop away from the core devices by identifying devices that connect to the core devices, and wherein the software causes the processor to identify devices that are two hops away from the core devices by identifying devices that connect to devices that connect to the core devices.

17. The non-transitory, computer-readable storage device of claim 15, wherein the software causes the processor to graphically represent the hierarchical topology, and wherein the graphical representation demarcates the core devices, a layer containing devices determined to be one hop away from the core devices, and a layer containing devices determined to be two hops away from the core devices.

18. The non-transitory, computer-readable storage device of claim 11, wherein the software causes the processor to graphically represent the hierarchical topology, and wherein the graphical representation demarcates the top layer from the other layer.

19. A computing device, comprising:
a network interface; and
a processor coupled to the network interface, wherein the processor is configured to:
interrogate devices in a network to obtain device information;
automatically determine which devices are at a top layer of a multi-layer hierarchical topology based on the device information;
receive input from a user to manually modify the determination as to which devices are at the top layer; and
based on those devices being determined to be core network devices, determine which of the other devices in the network are at another layer in the hierarchical topology.

20. The computing device of claim 19, wherein the processor is further configured to determine which devices are at the top layer by comparing the device information obtained from the devices during interrogation to a stored set of device designators previously deemed to be indicative of devices at the top layer.

21. The computing device of claim 19, wherein the processor is further configured to adjust an automatic determination as to which devices are at the top layer based on the received input from the user.

22. The computing device of claim 19, wherein determining which of the other devices in the network at another layer in the hierarchical topology comprises identifying devices that are one hop away from the devices determined to be at the top layer and separately identifying devices that are two hops away from the devices determined to be at the top layer.

23. The computing device of claim 19 further comprising an output device, wherein the processor is further configured to graphically represent the hierarchical topology on the output device, and wherein the graphical representation demarcates the top layer from the other layer.
